(19) United States
(12) Patent Application Publication
(10) Pub. No.: US 2005/0148305 A1
(43) Pub. Date: Jul. 7, 2005

(54) Wireless transceiver apparatus

(75) Inventor: Pat Tsao, Clifton, VA (US)

Correspondence Address: William R. Evans;Ladas & Parry, 26 West 61 Street, New York, NY, 10023, US

(73) Assignee: INTECS INTERNATIONAL, INC.

(21) Appl. No.: 10/752,433

(22) Filed: Jan. 6, 2004

(51) Int. Cl. H04B 1/44

(52) U.S. Cl. 455/78; 455/73

(57) ABSTRACT

The present invention is a wireless transceiver apparatus, comprised of a transceiver unit, a communication unit, a radio-receiving unit, and a switch unit. The switch unit is connected to the communication unit. The transceiver unit includes a skin-touch microphone, which is able to transform human voice into a first signal. The communication unit is able to emit a second signal, and the radio-receiving unit is able to receive the second signal. When the wireless transceiver apparatus is in First State, the switch unit is able to receive the first signal (which is in the form of a radio transmission) from the transceiver unit, and pass the received signal to the communication unit. When the wireless transceiver apparatus is in Second State, the switch unit is able to receive the second signal from the communication unit and pass the received signal to the transceiver unit, which then finally passes them to the radio-receiving unit.

### 1. FIELD OF THE INVENTION

The present invention relates to a wireless transceiver apparatus, especially a wireless transceiver apparatus having a skin-touch microphone and a wireless earpiece.

### 2. BACKGROUND OF THE INVENTION

Traditional mobile devices employ a microphone that picks up sounds waves transmitted through the air to receive a user's voice; therefore, background noise can and does seriously affect communication quality and efficiency. Furthermore, cellular phones on the market employ an earpiece and microphone to transmit signals. Most earpieces and microphones in the market rely on wired electrical circuit to transmit signals. The wired earpieces and microphones cause inconvenience to users. The present invention uses a cordless mechanism—a wireless transceiver apparatus with a skin-touch microphone and a wireless earpiece—to overcome the inconvenience.

### SUMMARY OF THE INVENTION

An objective of the invention is to use a wireless transceiver apparatus to transmit background noise-free voice signals between a user and a communication unit. This wireless transceiver apparatus comprises: a wireless transceiver unit, a switch unit, a radio-receiving unit and a communication unit. The transceiver unit turns human voice into a first signal, and the communication unit is able to emit a second signal.

When the wireless transceiver apparatus is in a first state, the switch unit is able to receive the first signal in the form of a radio transmission from the transceiver unit and pass the received signal to the communication unit.

When the wireless transceiver apparatus is in a second state, the switch unit is able to receive the second signal from the communication unit and pass the received signal to the transceiver unit, which then finally passes them to the radio-receiving unit.

### BRIEF DESCRIPTION OF THE DRAWINGS

FIG. 1 shows a wireless transceiver apparatus according to a first embodiment of the present invention.

FIG. 2 shows a wireless transceiver apparatus according to a second embodiment of the present invention.

FIG. 3 shows a radio-receiving unit of the present invention.

FIG. 4A shows a wireless transceiver unit according to a first embodiment of the wireless transceiver apparatus of the present invention.

FIG. 4B shows a wireless transmitting unit according to a second embodiment of the wireless transceiver apparatus of the present invention.

FIG. 5A shows a switch unit and communication unit according to a first embodiment of the wireless transceiver apparatus of the present invention.

FIG. 5B shows a switch unit and communication unit according to a second embodiment of the wireless transceiver apparatus of the present invention.

### DETAILED DESCRIPTION OF THE INVENTION

### First Embodiment

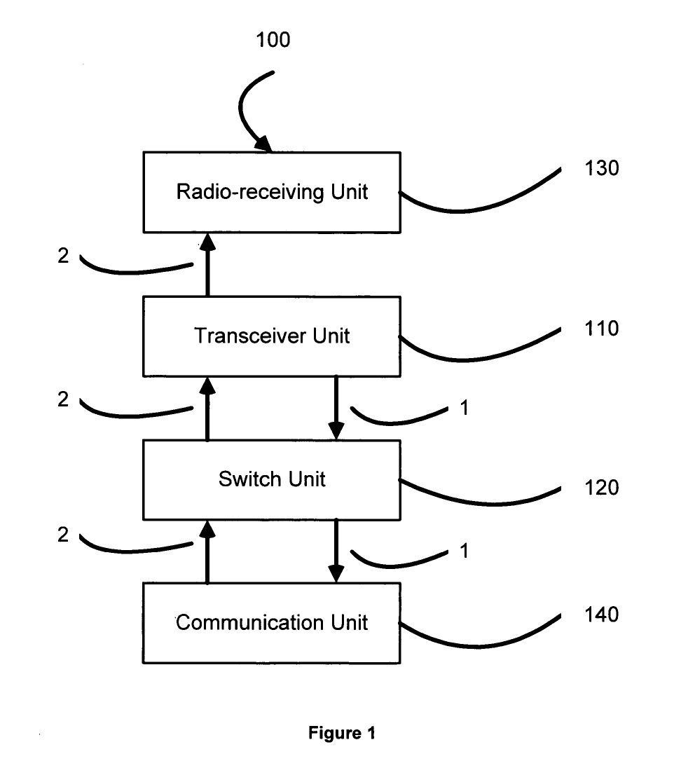

Please refer to FIG. 1, which shows a wireless transceiver apparatus 100 comprising a wireless transceiver unit 110, a switch unit 120, a radio-receiving unit 130, and a communication unit 140. The transceiver unit 110 is able to turn human voice into a first signal, and the communication unit 140 is able to emit a second signal.

When the transceiver apparatus 100 is in a first state, the switch unit 120 is able to receive the first signal from the transceiver unit 110 and pass the received signal to the communication unit 140.

When the transceiver apparatus 100 is in a second state, the switch unit 120 is able to receive the second signal from the communication unit 140 and pass the received signal to the transceiver unit 110, which then finally passes them to the radio-receiving unit 130.

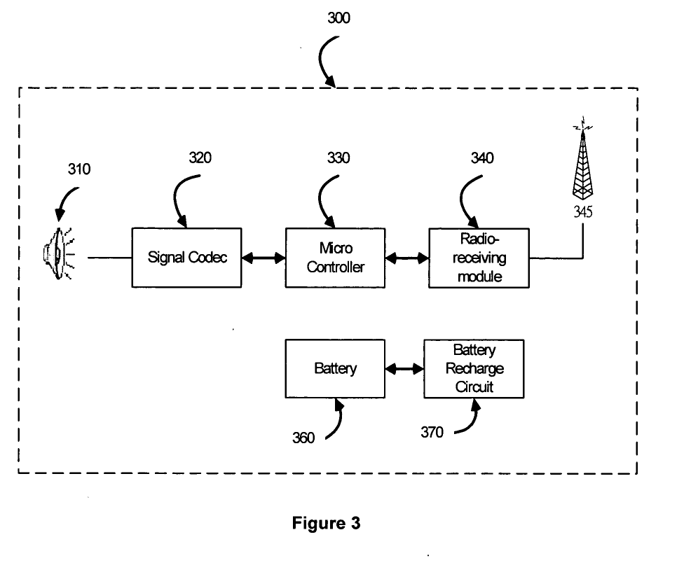

In the above embodiment, the communication unit 140 can be a cellular phone, a two-way radio or other telecommunications device. The radio-receiving unit 130 can be a wireless earpiece, wireless speakerphone or other wireless voice utterance device. More details about the operation and the architecture of this wireless transceiver apparatus 100 will be described below in sections about FIGS. 3, 4A and 5A.

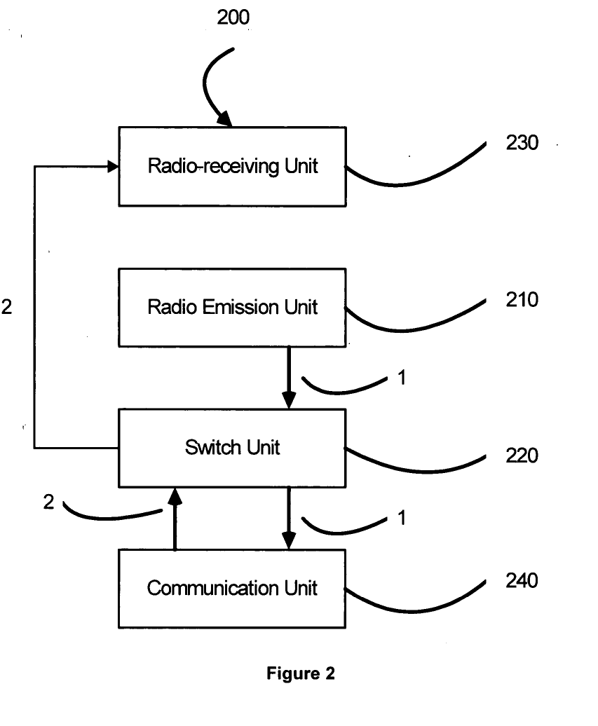

In FIG. 3, a radio-receiving unit 300 (coresponding to the radio-receiving unit 130 in FIG. 1 and radio-receiving unit 230 in FIG. 2) comprises a voice output device 310, a signal codec (coder and decoder) 320, a micro-controller 330, a unidirectional radio-receiving module 340, an antenna 345 for receiving signal, a battery 360, and a battery recharge circuit 370.

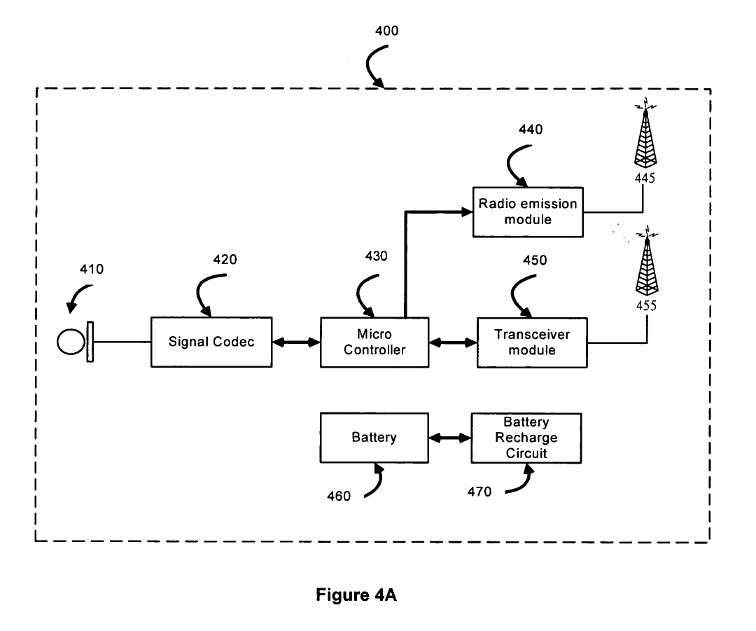

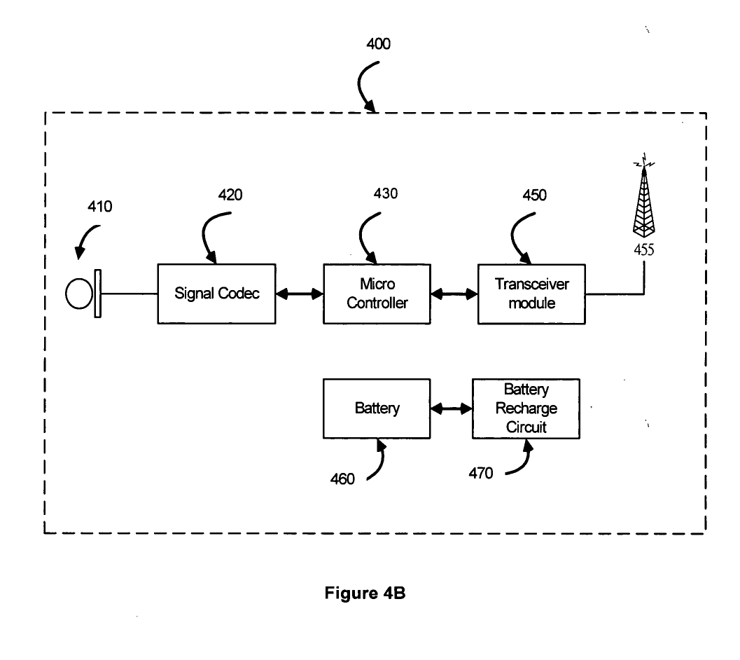

In FIG. 4A, a wireless transceiver unit 400 (corresponding to the transceiver unit 110 in FIG. 1) comprises a skin-touch microphone 410, a signal codec 420, a micro-controller 430, a wireless transmitting module 440, an antenna 445 for emitting signal, a wireless transceiving module 450, a battery 460, an antenna for receiving and transmitting signal 455, a battery 460, and a battery recharge circuit 470.

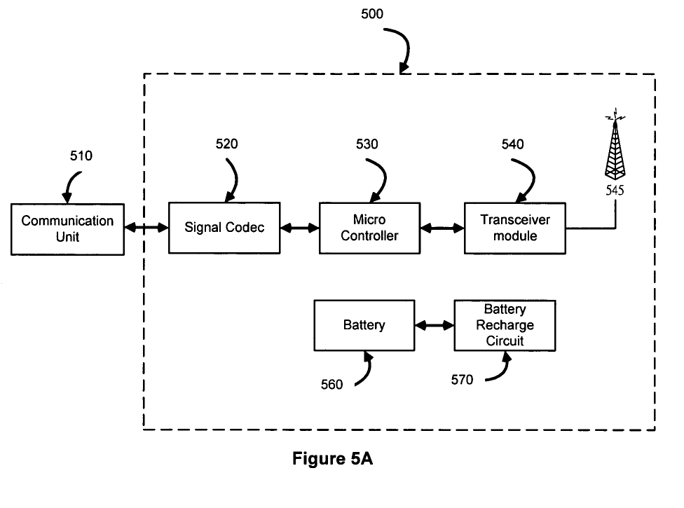

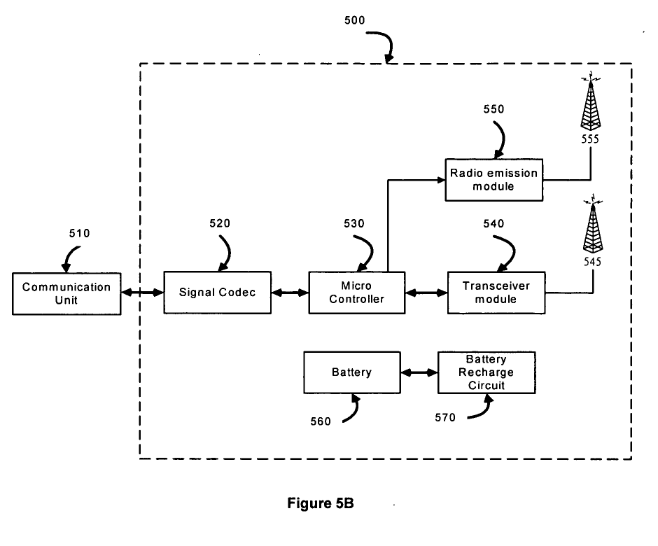

FIG. 5A shows a communication unit 510 (corresponding to the communication unit 140 in FIG. 1) and a switch unit 500 (corresponding to switch unit 120 in FIG. 1). The switch unit 500 comprises a signal codec 520, a micro-controller 530, a wireless transceiver module 540, an antenna 545 for emitting and receiving signal, a battery 560, and a battery recharge circuit 570.

Signals received by the communication unit 510 will be passed along in the following sequence: to the signal codec 520, to the micro-controller 530, to the transceiver module 540, and then through the antenna 545 to the antenna 455.

Signals received by the antenna 455 will be passed along in the following sequence: to the micro-controller 430, to the transceiver module 440, and then through antenna circuit 445 to antenna circuit 345 of the radio-receiving unit 300.

Signals received by antenna circuit 345 will be passed along in the following sequence: to the radio-receiving module 340, to the micro-controller 330, to the signal codec 320, and then to the voice output device 310. Finally, a user can listen to voices from the voice output device 310 (for example, a wireless earpiece).

User utterances received by the skin-touch microphone 410 will be passed along in the following sequence: to the signal codec 420, to the micro-controller 430, to the wireless transmitting module 450, and then through the antenna 455 to the antenna 345 of the unit 300.

Signals received by the antenna 345 will be passed along in the following sequence: to the radio receiving module 340, to the micro-controller 330, to the signal codec 320, and then finally to a voice output device 310 such as a wireless earphone.

### Second Embodiment

FIG. 2 shows a wireless transceiver apparatus 200 comprises a radio transmitting unit 210, a switch unit 220, a radio-receiving unit 230, and a communication unit 240. The radio transmitting unit 210 is able to turn human voice into a first signal, and the communication unit 240 is able to emit a second signal.

When the wireless transceiver apparatus 200 is in a first state, the switch unit 220 is able to receive the first signal 1 from the radio transmitting unit 210 and pass the received signal 1 to the communication unit 240.

When the wireless transceiver apparatus 200 is in a second state, the switch unit 220 is able to receive the second signal 2 from the communication unit 240 and pass the received signal 2 to the radio-receiving unit 230.

In the above embodiment, the communication unit 240 can be a cellular phone, two-way radio or other telecommunication devices. The radio-receiving unit 230 can be a wireless earpiece, wireless speakerphone or other wireless voice utterance devices. More details about the operation and architecture of this wireless transceiver apparatus 200 are described in the following sections about FIGS. 3, 4B and 5B.

In FIG. 3, a radio-receiving unit 300 (corresponding to the receiving unit 130 in FIG. 1 and the receiving unit 230 in FIG. 2) comprises a voice output device 310, a signal codec (coder and decoder) 320, a micro-controller 330, a radio-receiving module 340, an antenna 345 for receiving signal, a battery 360, and a battery recharge circuit 370.

In FIG. 4B, a wireless transmitting unit 400 (corresponding to the transceiver unit 210 in FIG. 2) comprises a skin-touch microphone 410, a signal codec 420, a micro-controller 430 a wireless transceiver module 450, an antenna 455 a battery 460, and a battery recharge circuit 470.

FIG. 5B shows a communication unit 510 (corresponding to the communication unit 240 in FIG. 2) and a switch unit 500 (corresponding to the switch unit 220 in FIG. 2). The switch unit 500 comprises a signal codec 520, a micro-controller 530, a wireless transceiver module 540, an antenna 545, a radio transmiting module 550, an antenna 555, a battery 560, and a battery recharge circuit 570.

Signals received by the communication unit 510 will be passed along in the following sequence: to the signal codec 520, to the micro-controller 530, to the radio transmitting module 550, and finally through the antenna 555 to the antenna circuit 345 of the radio-receiving unit 300.

Signals received by the antenna 345 will be passed along in the following sequence: to the radio-receiving module 340, to the micro-controller 330 and signal codec 320, and finally through the voice output device 310, such as a wireless earpiece, in order to output the voice to the user.

User utterances received by the skin-touch microphone 410 will be passed along in the following sequence: to the signal codes 420, to the micro-controller 430, to the transceiver module 450, and finally through the antenna 455 to the antenna 545 of the switch unit 500.

Signals received by the antenna 545 will be passed along in the following sequence: to the transceiver module 540, to the micro-controller 530, to the signal codec 520, and finally to the communication unit 510.

The main difference between the first embodiment and second embodiment is that in the second embodiment, the radio-receiving unit 230 (refer to FIG. 2) receives the second signal from the switch unit 220 directly, and in the first embodiment, the radio-receiving unit 130 (refer to FIG. 1) does not need the transceiver unit 110 (refer to FIG. 1) as an intermediary to transmit the signals.

Furthermore, the present invention also contemplates that the switch unit and the communication unit can be combined to achieve the convenience and smaller size required for a mobile device. For example, a “Bluetooth” wireless module can be built into a cellular phone. This will overcome the inconvenience of using a traditional hands-free headset that must be linked to a cellular phone by a cumbersome wire.

There are many specific details shown on the above descriptions; however, these are not intended to constrain this invention to such details or scope. They are provided only for the purpose of explaining various possible physical configurations of the present invention. The scope of the present invention is determined by the following claims and equivalents.

1. A wireless transceiver apparatus, comprising:
a. a transceiver unit, including a skin-touch microphone, which is able to transform human voice to a first signal;
b. a communication unit capable of transmitting a second signal;
c. a radio-receiving unit for receiving the second signal; and
d. a switch unit connected to the radio-receiving unit;
wherein when the wireless transceiver apparatus is in a first state, the switch unit receives the first signal from the transceiver unit and passes the received signal to the communication unit; and
when the wireless transceiver apparatus is in a second state, the switch unit receives the second signal from the communication unit and passes the received signal to the transceiver unit, and finally to the radio-receiving unit.

2. The wireless transceiver apparatus as claimed in claim 1, wherein the radio-receiving unit is a wireless earpiece.

3. The wireless transceiver apparatus as claimed in claim 1, wherein the communication unit is a cellular phone.

4. A wireless transceiver apparatus, comprising:
a. a radio transmitting unit, including a skin-touch microphone capable of transforming human voice into a first signal;
b. a communication unit for transmitting a second signal;
c. a radio-receiving unit for receiving the second signal; and
d. a switch unit connected to the radio-receiving unit;
wherein when the wireless transceiver apparatus is in a first state, the switch unit receives the first signal from the transceiver unit and passes the received signal to the communication unit; and
when the wireless transceiver apparatus is in a second state, the switch unit receives the second signal from the communication unit and passes the received signal to the transceiver unit, and finally to the radio-receiving unit.

5. The wireless transceiver apparatus as claimed in claim 4, wherein the radio-receiving unit is a wireless earpiece.

6. The wireless transceiver apparatus as claimed in claim 4, wherein the communication unit is a cellular phone.
